(19) United States
(12) Patent Application Publication
(10) Pub. No.: US 2025/0002110 A1
(43) Pub. Date: Jan. 2, 2025

(54) FRAME ASSEMBLY FOR A BICYCLE WHICH IS DRIVINGLY SUPPORTRD BY AN ELECTRIC MOTOR, AND ELECTRIC BICYCLE

(71) Applicant: Porsche eBike Performance GmbH, Ottobrunn (DE)

(72) Inventors: Stefan Bender, Loechgau (DE); Edmund Sander, Leonberg (DE)

(21) Appl. No.: 18/705,542

(22) PCT Filed: Jul. 4, 2022
(86) PCT No.: PCT/EP2022/025308

§ 371 Date: Apr. 27, 2024

(30) Foreign Application Priority Data
Oct. 28, 2021 (DE) 10 2021 128 093.1

(51) Int. Cl. B62K 3/02; B62K 25/28; B62M 6/55

(52) U.S. Cl. CPC B62K 3/02; B62K 25/28; B62M 6/55; B62K 2204/00

(57) ABSTRACT

A frame assembly for a bicycle that is drivingly supported by an electric motor (4) includes a frame (6) that has at least one seat tube (8), a lower tube (10) and an upper tube (12). The lower tube (10) and the seat tube (8) are connected together by the upper tube (12) and a support assembly (22). A holding device (24) for the electric motor (4) is provided in the region of the support assembly (22). A housing (20) of the electric motor (4) is formed as part of the support assembly (22) and is connected to the seat tube (8) and the lower tube (10) via the holding device (24). An electric bicycle (4) that includes the frame assembly (2) also is provided.

### FIELD OF THE INVENTION

The invention relates to a frame arrangement for a bicycle that is supported in technical driving terms by means of an electric motor. The frame arrangement has a frame that has at least one seat tube, a down tube and a top tube. The down tube and the seat tube are connected to each other by the top tube and by a support arrangement. Retention means for the electric motor are provided in the region of the support arrangement.

### BACKGROUND OF THE INVENTION

A frame arrangement, as described above, is adequately known from the prior art. For example, European Patent Application EP 3 109 145 A1 discloses a frame arrangement in which the support arrangement is in the form of a closed frame portion in which an electric motor is intended to be inserted and to be fixed by means of corresponding retention means. Frame arrangements are also known in which the support arrangement is simply in the form of a lower frame portion that acts as an abutment for the electric motor. However, all known frame arrangements are based on the principle of providing a closed frame on which an electric motor is placed. Particularly with frame-like openings, as a result of the slightest tolerance errors, occurrences of imprecise fitting may occur and can be compensated for only with difficulty. The assembly complexity both for the production of the frame and for the precisely fitting insertion of the electric motor is also very high.

An object of the invention is therefore to avoid the above-mentioned disadvantages in a simple and cost-effective manner.

### SUMMARY OF THE INVENTION

This object is achieved according to the invention in that at least one housing of the electric motor is in the form of a portion of the support arrangement and is connected to the seat tube and the down tube via the retention means. The frame of the frame arrangement can thereby initially be configured to be significantly lighter since the housing of the electric motor takes on support functions. In addition, redundancies, over specifications or occurrences of imprecise fitting can be eliminated in a simple manner since the housing of the electric motor in addition to the top tube forms the connection member between the down tube and the seat tube.

In some embodiments, the housing of the electric motor is a metal housing, thereby ensuring high support functions.

In one embodiment, the support arrangement has an abutment arrangement that extends above the electric motor. The support arrangement can be configured to be partially hollow and acts as an abutment for the electric motor.

In a particularly advantageous manner, exclusively the housing of the electric motor forms the support arrangement between the down tube and the seat tube. Thus, over specifications of the frame arrangement are avoided.

The housing of the electric motor may have retention means for a rear structure and/or a resilient member for the rear structure. In this manner, the frame can be produced in an even simpler manner.

For technical safety and technical design reasons, it is advantageous for a side of the housing facing away from the top tube to adjoin in terms of form a side of the down tube facing away from the top tube. Thus, when the bicycle is placed on uneven ground, a jamming or tilting of the frame or the housing of the electric motor is avoided.

The object also is achieved with an electric bicycle having a frame arrangement constructed in this manner. The invention is explained in greater detail with reference to drawings.

### BRIEF DESCRIPTION OF THE DRAWINGS

FIG. 1 is a side view of a first embodiment of a frame arrangement according to the invention.

FIG. 2 is a side view of the frame arrangement from FIG. 1 with an electric motor inserted.

FIG. 3 is a second side view of a second embodiment of a frame arrangement according to the invention.

### DETAILED DESCRIPTION

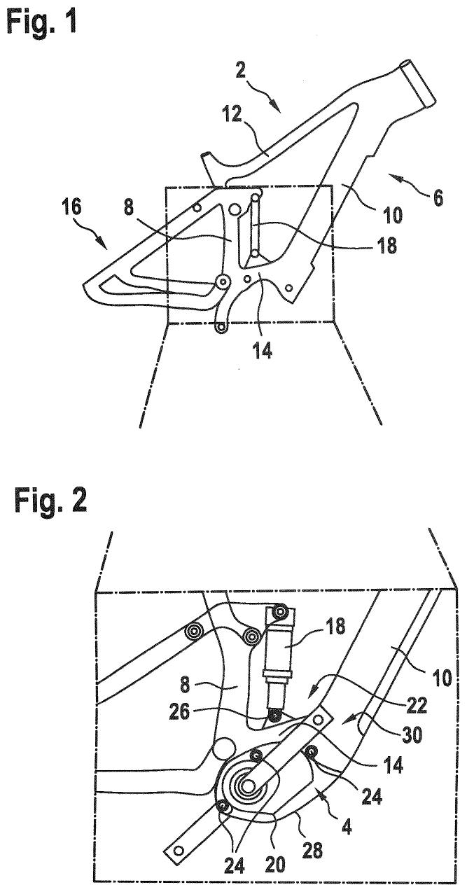

FIG. 1 shows a side view of a frame arrangement 2 according to the invention for a bicycle which is not illustrated in greater detail and which is supported in technical driving terms by means of an electric motor 4 (see FIG. 2). The frame arrangement 2 further has in this instance a frame 6 that comprises a seat tube 8, a down tube 10 and a top tube 12 that connects the seat tube 8 and the down tube 10. An end of the down tube 10 opposite the top tube 12 is connected to the seat tube 8 by means of an abutment arrangement 14 which extends above the electric motor 4. The abutment arrangement 14 is configured to be partially hollow and acts as an abutment face for the electric motor (see FIG. 2). FIG. 1 further shows a rear structure 16 that is connected to the seat tube 8 in known manner and has a resilient member 18.

As illustrated in detail in FIG. 2, a housing 20 of the electric motor 4 is in the form of a portion of a support arrangement 22 for the seat tube 8 and 12. The support arrangement 22 is completed by the abutment arrangement 14. Retention means 24 connect the housing 20 to the seat tube 8, the down tube 10 and the abutment arrangement 14. Screw connections are provided in this instance as retention means 24. The resilient member 18 is in the present exemplary embodiment operationally connected to the abutment arrangement 14 via a retention means 26. The housing 20 of the electric motor 4 is in the present exemplary embodiment in the form of a metal housing and thus provides the support arrangement 22 with the necessary stability. However, it should also be clear that many materials can be used as a housing material.

In order to prevent uncontrolled tilting of the housing 20 with a ground surface, an end 28 of the housing 20 facing away from the top tube 12 adjoins an end 30 of the down tube 10, facing away from the top tube 12.

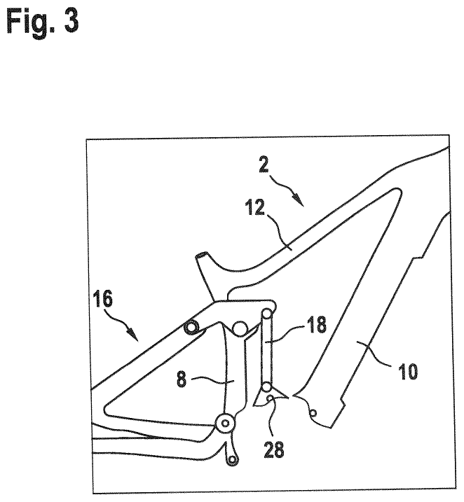

FIG. 3 shows a second embodiment of the frame arrangement 2 according to the invention. This frame arrangement 2 substantially corresponds to the frame arrangement from FIGS. 1 and 2, but the abutment arrangement 14 has been omitted so that the housing 20 of the electric motor 4 exclusively forms the support arrangement 22. The resilient member 18 is in this instance intended to be connected to the retention means 26 on the housing 20 of the electric motor.

It should be clear that, as a result of the configuration of the housing 20 of the electric motor 4 as a portion of the support arrangement 22, on the one hand, weight can be saved and, on the other hand, the assembly of the frame arrangement 2 can be significantly simplified.

1. A frame arrangement for a bicycle that is supported in technical driving terms by an electric motor (4), the frame arrangement comprising: a frame (6) that has at least one seat tube (8), a down tube (10) and a top tube (12), the down tube (10) and the seat tube (8) being connected to each other by means of the top tube (12) and by a support arrangement (22), retention means (24) for the electric motor (4) being provided in a region of the support arrangement (22), the electric motor (4) including at least one housing (20), the housing forming a portion of the support arrangement (22) and being connected to the seat tube (8) and the down tube (10) via the retention means (24).

2. The frame arrangement of claim 1, wherein the housing (20) of the electric motor (4) is a metal housing.

3. The frame arrangement of claim 1, wherein the support arrangement (22) has an abutment arrangement (14) that extends above the electric motor (4).

4. The frame arrangement of claim 1, wherein the housing (20) of the electric motor (4) forms the support arrangement (22) between the down tube (10) and the seat tube (8).

5. The frame arrangement of claim 1, wherein the housing (20) of the electric motor (4) has retention means (26) for a rear structure (16).

6. The frame arrangement of claim 1, wherein a side (28) of the housing (20) facing away from the top tube (12) adjoins a side (30), of the down tube (10) facing away from the top tube (12).

7. An electric bicycle having the frame arrangement (2) of claim 1.

8. The frame arrangement of claim 5, wherein the housing (20) of the electric motor (4) further has a resilient member (18) for the rear structure (16).

9. The frame arrangement of claim 1, wherein the housing (20) of the electric motor (4) has a resilient member (18) for the rear structure (16).
